(19) United States
(12) Patent Application Publication
(10) Pub. No.: US 2009/0309731 A1
(43) Pub. Date: Dec. 17, 2009

(54) Method and system for tracking objects using Global Positioning System (GPS) receiver built in the Active Radio Frequency ID (RFID) receiver

(76) Inventor: Kwok Wai Chan, Ap Lei Chau (CN)

Correspondence Address: WHITE-WELKER & WELKER, LLC, P.O. BOX 199, CLEAR SPRING, MD, 21722-0199, US

(21) Appl. No.: 12/140,235

(22) Filed: Jun. 16, 2008

(51) Int. Cl. G06K 7/00; G01S 1/00

(52) U.S. Cl. 340/572.1; 342/357.07

(57) ABSTRACT

A method and system for tracking objects using Global Positioning System (GPS) receiver built in the Active Radio Frequency ID (RFID) receiver. The method comprises the steps of determining the position of the object using GPS receiver, detecting the object in a small range using an active RFID, sending the location data using Global System for Mobile Communication (GSM) to a database which stores the location data, and using a Geographical Information System (GIS) application to plot the location data onto a map, to track the exact location of the object. The system comprises one or more active RFID tags wherein said tags send out a hard coded ID on predefined intervals to be received and interpreted by a GPS and Active RFID receiver; a GPS; an Active RFID receiver; and a fixed IP remote server receives the output message generated by the Active RFID receiver.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to object tracking. More specifically, the present invention relates to a method and system for tracking objects using Global Positioning System (GPS) receiver built in the Active Radio Frequency ID (RFID) receiver.

### BACKGROUND OF THE INVENTION

Many tracking system are know and currently being used in the prior art. For example, shipping industries, supply chain management, and even air and land travelers have begun to use object tracking to reduce the number of lost shipments, luggage, and to provide means for identifying a location of lost or misdirected property.

U.S. Pat. No. 6,624,752 discloses a system and a method for detecting and identifying an object. More specifically the invention relates to a tag for attachment e.g. to luggage, the tag being adapted for transmission of an identifiable signal and a receiver for detecting and identifying the signal. The invention is concerned with use of the Internet and handheld terminals such as mobile phones in combination with Bluetooth or DECT technology for communicating information in relation to the object.

U.S. Pat. No. 7,315,281 discloses a method of determining a geographical location of an asset tracking device, includes searching, by the asset tracking device, for available location determination schemes at the geographical location, selecting one of the available location determination schemes, and determining coordinates of the geographical location using the selected location determination scheme. Some embodiments also include making a decision based, at least in part, upon the geographical location coordinates determined by using the selected location determination scheme. Some embodiments include transmitting a location message, the location message including the coordinates of the geographical location and an indication as to the selected location determination scheme.

U.S. Pat. No. 7,298,264 discloses a Radio Frequency Identification (RFID) system that tracks tags in real-time based on EPC codes and on other priority codes written into transponder memory fields of the tags. As an example, a priority code may be written into a memory of an RFID transponder identifying a high-value item or a small high-value item that is likely to be stolen. Based on the use of this priority code, those items can be preferentially tracked as opposed to items of low value or size such that they are unlikely to be stolen. Such use of priority codes and local filtering alleviates the need to go back to large centralized databases associating unique numbers with other parameters and potentially the history of the item.

U.S. Pat. No. 7,231,355 discloses a system and method track both passenger and baggage during passenger trips, improving trip security, reducing lost baggage, allowing remote baggage check-in and retrieval, and allowing billing and financial transactions among system users. A passenger identification code (PIC) identifies a passenger, a trip starting location, and both a carrier and a final destination. A baggage identification code (BIC) is assigned to each piece of a trackable baggage set. At the trip starting location the PIC and BIC are wirelessly transmitted to an integrated travel information system (ITIS) using a wireless electronic device (WED). At a trip segment end the ITIS locates the baggage set and directs it to a transportation vehicle located by the ITIS. The ITIS directs the passenger to the transportation vehicle via a WED message. The WED transmits an end-of-trip signal to the ITIS at the final destination.

U.S. Pat. No. 7,195,159 discloses methods, systems, and apparatuses for tracking items automatically are described. A radio frequency identification (RFID) tag is used with a material tracking system to enable the identification and locating of aviation assets in an airport environment. For example, passive (e.g., non-battery) RFID tags are attached to an aviation asset. Antennas are placed at locations where monitoring of assets is necessary. A local controller and RFID reader use the antennas to communicate with the passive RFID tags to determine the identity and location of the asset.

U.S. Pat. No. 7,064,663 teaches an object location system having tags for tracking objects. A finder and tags each have a memory, and RF send and receive capabilities. The finder stores tag identification codes in its memory, and associates the tag identification codes with descriptive text identifying an object to a user. A user selects a descriptive text identifier to locate an object, and the finder transmits a search RF signal including the tag identification code to locate the tag attached to the desired object. The tags receive the search RF signal and compare the transmitted tag identification code with their own stored identification codes. A tag responds to the finder by transmitting a found RF signal if the transmitted and stored tag identification codes match. The finder signals to the user that the object with the selected descriptive text identifier has been located, and indicates a relative proximity of the finder to the object.

The prior art discussed above and known fails for many reasons. One main reason being that the systems disclosed do not teach to teach an active RFID tag that is small, cheap, and has low power consumption that can be carried or easily and hardly imperceptivity attached to any person, truck, or object.

Additionally, the prior art methods discussed also fail for various reason, the most important being that they do not teach a method for object tracking that includes a receiver that can send out a GPS location to the Internet or other multi-user network by means of global wireless telecom service or fixed line Internet or other multi-user network access.

Thus, the prior art fails to teach, disclose or make obvious an object tracking system that makes the tracking truly global and keeps the cost very low.

### SUMMARY OF THE INVENTION

The present invention is a method and system for tracking objects using Global Positioning System (GPS) receiver built in the Active Radio Frequency ID (RFID) receiver. The method comprises the steps of determining the position of the object using GPS receiver, detecting the object in a small range using an active RFID, sending the location data using Global System for Mobile Communication (GSM) to a database which stores the location data, and using a Geographical Information System (GIS) application to plot the location data onto a map, to track the exact location of the object. Historical location data can be used for reporting.

The system for tracking objects using Global Positioning System (GPS) receiver built in the Active Radio Frequency ID (RFID) receiver is comprised of: an active RFID tag; a GPS; an Active RFID receiver; and fixed IP remote server.

The active RFID tag can be short range or long range. The tag will send out its hard coded ID on predefined interval that can be received and interpreted by a GPS and Active RFID receiver. The power consumption is very low and can be powered by a coin battery. The tag can also be powered by onboard electrical system.

When an active RFID tag(s) is/are in range, the tag ID together with the GPS latitude and longitude, and UTC fix time will be sent out through a serial port. Whenever the GPS and Active RFID receiver receives an ID, the message will be sent out as shown in FIG. 2.

The output message will be sent to a fixed IP remote server via: GPRS modem (GSM network in Europe, CDMA network in US), the Internet via connection to a PC if there is a PC program for connection; or Plug into a local area network (LAN) that provides internet access.

A server program installed on the fixed IP server that will receive all message from the Internet and analysis the message. Message data is stored on any RDBMS. A GIS such as Google Earth can be used to display the location of the tag via web server.

It is an object of the present invention to teach an active RFID tag that is small, cheap, and has low power consumption that can be carried or easily and hardly imperceptivity attached to any person, truck, or object.

Another objective of the present invention is to teach a receiver that can send out a GPS location to the Internet or other multi-user network by means of global wireless telecom service or fixed line Internet or other multi-user network access. This makes the tracking truly global and keeps the cost very low.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the process of the present invention; and

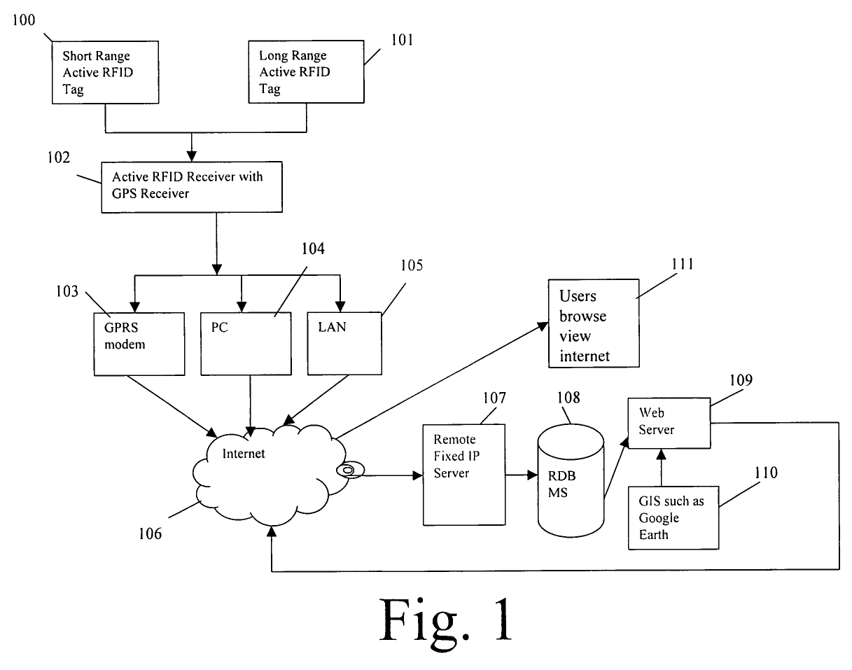

FIG. 2 illustrates the receive output signal for an active RFID used by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, functional, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Now referring to the figures, a method and system for tracking objects using a Global Positioning System (GPS) receiver with a built in Active Radio Frequency ID (RFID) receiver is shown and discussed. The system for tracking objects using a Global Positioning System (GPS) receiver built in the Active Radio Frequency ID (RFID) receiver is comprised of, an active RFID tag; a GPS; an Active RFID receiver; and fixed IP remote server.

An active RFID tag (very low cost) can be short range 100 or long range 101. The tags 100 and 101 will send out a hard coded ID on predefined interval to be received and interpreted by a GPS and Active RFID receiver 102. The power consumption of an active RFID tag 100 and 101 is very low and can be powered by a coin battery.

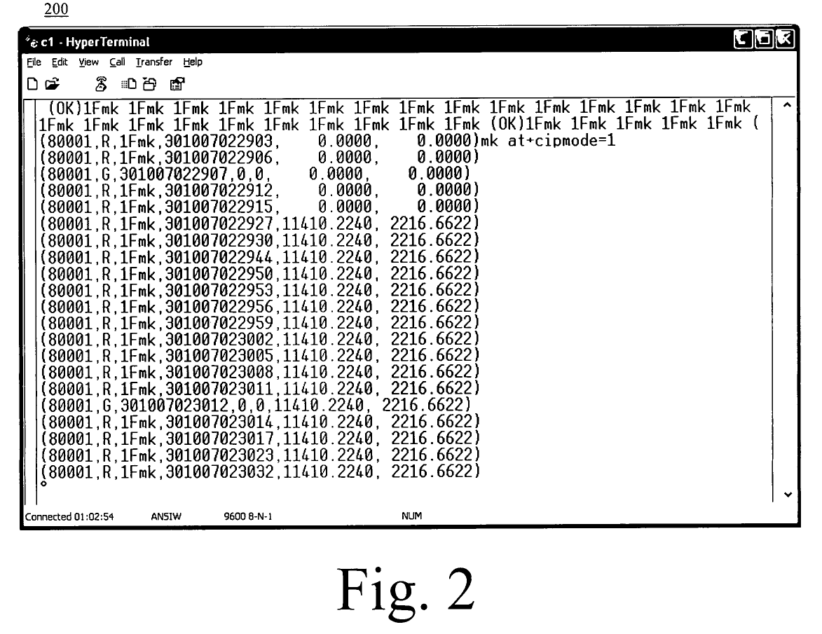

When an active RFID tag(s) 100 and 101 is/are in range, the tag ID together with the GPS latitude and longitude, and UTC fix time will be sent out through a serial port of the GPS and Active RFID receiver 102. FIG. 2 illustrates the output from the receiver (80001,R,1Fmk,301007023032,11410.2240,2216.6622). 8001 is the reader number, 1Fmk is the active rfid tag ID, 301007023032 is the UTC fix time, 11410.2240 is the longitude, 2216.6622 is the latitude. Whenever there the GPS and Active RFID receiver 102 receives an ID from the tags 100 and 101, the message 200 will be sent out as shown in FIG. 2.

The GPS and Active RFID receiver 102 can be connected to a GPRS modem 103 or a PC 104 that connected to the Internet 106 or a LAN 105 that connected to Internet 106. The output message will be sent to a fixed IP remote server 107 via: GPRS modem 103 (GSM network in Europe, CDMA network in US). It should be appreciated that there can be other types of modems used in the future as wireless technology develops; the Internet 106 via connection to a PC 104 if there is a PC program for connection; or Plug into a local area network (LAN) 105 that provides Internet 106 access.

A server program installed on the fixed IP server 107 that will receive all message from the Internet 106 and analysis the message. Message data such as Reader Number, RFID tag number, GPS latitude and longitude will be stored on any RDBMS 108. A GIS 110 such as Google Earth can be used to display the location of the tags 100 and 101 via a web server 109 for viewing over the Internet 106 via a browser 111.

The active RFID tag 100 and 101 is small, cheap and low power consumption that can be carried by any people, truck or object. The GPS and Active RFID receiver 102 will send out the GPS location via the Internet 106 by means of global wireless telecom service or fixed line Internet. This makes the tracking truly global and keeps the cost very low. The GPS and Active RFID receiver 102 of the present invention can be a portable station (using GPRS modem) to track or counting the traffic at any point (because it has GPS data).

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A system for tracking objects consisting of:
one or more active RFID tags wherein said tags send out a hard coded ID on a predefined interval to be received and interpreted by a GPS and an Active RFID receiver;
a GPS;
an Active RFID receiver wherein said Active RFID receiver receives the hard coded ID sent by the tags and generates an output message; and
a fixed IP remote server receives the output message generated by the Active RFID receiver.

2. The system for tracking objects of claim 1 wherein, the active RFID tags may be short range or long range.

3. The system for tracking objects of claim 1 wherein, a tag is powered by a coin battery or onboard electrical system.

4. The system for tracking objects of claim 1 wherein, when an active RFID tag(s) is in range, the tag ID together with the GPS latitude and longitude, and UTC fix time will be sent out as an output message through a serial port of the GPS and Active RFID receiver.

5. The system for tracking objects of claim 1 wherein, the output message from the receiver further comprises
a reader number;
a UTC fix time; and
a longitude and latitude.

6. The system for tracking objects of claim 1 wherein,
the GPS and Active RFID receiver are connected to a GPRS modem that is connected to the Internet; and
the output message is sent to a fixed IP remote server.

7. The system for tracking objects of claim 1 wherein,
the GPS and Active RFID receiver are connected to a PC that is connected to the Internet; and
the output message is sent to a fixed IP remote server

8. The system for tracking objects of claim 1 wherein,
the GPS and Active RFID receiver are connected to a LAN that is connected to Internet; and
the output message is sent to a fixed IP remote server

9. The system for tracking objects of claim 6 wherein, a server program is installed on the fixed IP server that receives all message from the Internet and analyses the message data and sends it to a RDBMS for storage.

10. The system for tracking objects of claim 9 wherein, a GIS displays the location of the tags via a web server for viewing over the Internet via a browser.

11. A method for tracking objects consisting the steps of:
providing one or more active RFID tags;
sending out a hard coded ID on a predefined interval to be received and interpreted by a GPS and Active RFID receiver by an active RFID tag;
provide a GPS;
receiving the hard coded ID sent by the tags by an Active RFID receiver;
generating an output message by the Active RFID receiver; and
receiving the output message by a fixed IP remote server.

12. The method for tracking objects of claim 11 wherein, the active RFID tags may be short range or long range.

13. The method for tracking objects of claim 11 wherein, a tag is powered by a coin battery.

14. The method for tracking objects of claim 11 further comprising the step of,
sending a UTC fix time out together with the tag ID and GPS latitude and longitude as an output message through a serial port of the tag to a GPS and Active RFID receiver when an active RFID tag(s) is in range.

15. The method for tracking objects of claim 11 wherein, the output message from the receiver further comprises
a reader number;
a UTC fix time; and
a longitude and latitude.

16. The method for tracking objects of claim 11 further comprising the steps of,
connecting the GPS and Active RFID receiver are to a GPRS modem;
connection said GPRS modem to the Internet; and
sending the output message to a fixed IP remote server.

17. The method for tracking objects of claim 11 further comprising the steps of,
connecting the GPS and Active RFID receiver to a PC;
connecting the PC to the Internet; and
sending the output message to a fixed IP remote server

18. The method for tracking objects of claim 11 wherein,
connecting the GPS and Active RFID receiver to a LAN
connecting the LAN to the Internet; and
sending the output message to a fixed IP remote server

19. The method for tracking objects of claim 16 further comprising the steps of,
installing a server program on the fixed IP server that receives all messages from the Internet and analyses the message data; and
sending messages form the fixed IP server to a RDBMS for storage.

20. The method for tracking objects of claim 19 further comprising the steps of,
displaying on a GIS the location of the tags via a web server; and
viewing the location of the tags over the Internet via a browser.
